(19) United States
(12) Patent Application Publication
(10) Pub. No.: US 2015/0120091 A1
(43) Pub. Date: Apr. 30, 2015

(54) COMPUTER IMPLEMENTED METHOD OF AIRCRAFT SELECTION

(71) Applicant: Steve N. Demy, Victoria (CA)

(72) Inventor: Steve N. Demy, Victoria (CA)

(21) Appl. No.: 14/261,606

(22) Filed: Apr. 25, 2014

(30) Foreign Application Priority Data
Oct. 28, 2013 (CA) 2831196

(51) Int. Cl. G06Q 10/02; G06Q 50/30

(52) U.S. Cl. CPC G06Q 10/02; G06Q 50/30
USPC 701/3

(57) ABSTRACT

A computer implement method of aircraft selection involves providing parameters and a set of logic rules reflecting laws, regulations and policies relating to safe operation of an aircraft, along with a database of aircraft relating to a fleet of aircraft of the same type. There is input into a computer processor a request for an aircraft to fulfil a mission at a time a pilot declares readiness for an aircraft. The computer processor makes a selection from the database of aircraft a first subset of aircraft that are available and capable of safely performing the mission.

### FIELD

There is described a computer implemented method of aircraft selection, that was developed to service the needs of a flying club.

### BACKGROUND

Flight training schools and flying clubs (“operators”) rent aircraft to pilots and student pilots on an hourly basis, in order to provide planning assurance to the pilot and to manage the demand for the operator, the aircraft are reserved, or booked in advance. A reservation system allows the pilot to specify which aircraft (and flight instructor if applicable) is to be reserved, the hour and the duration of the proposed flight. At the time of rental the aircraft is allocated to the pilot subject to a number of conditions. Amongst other things, the aircraft's maintenance condition, its fuel load, its defect status, its prompt return by the previous pilot, weather conditions, passenger and instructor timeliness etc. will determine if the pilot is able to proceed with the rental as planned, or may need to cancel the flight. If everything goes as planned, the pilot is assigned the aircraft at the intended time and conducts the flight. When the operation is busy, any substantial delay may lead to a flight cancellation because the remaining time reservation can become insufficient to carry out the intended flight. The operator operates a fleet of aircraft that are similar, but not identical to each other. The aircraft differ in empty weight and balance, have different fuel loads and capacities, have various capabilities and restrictions and will, from time to time have maintenance items and defects that may render the aircraft unsuitable for an intended mission. The same aircraft may be suitable for a different mission—one where the cabin load is different or the intended flight duration is different, or the intended flight exercises differ. The pilot has an obligation to conduct pre-flight planning to ensure that the aircraft is operated within its weight and balance limitations, that scheduled and special maintenance items are in compliance and that the aircraft has sufficient fuel to conduct the flight safely. The pilot must analyse the specific aircraft and its logbook with reference to the intended load of people, baggage and fuel. If the intended aircraft is unsuitable, switching to another aircraft introduces the need for re-planning, which consumes time. Pilots are accustomed to a significant cancellation rate and operators make less than ideal utilization of the aircraft in the fleet because imperfect logistics results in intervals of aircraft down time. This mechanism of reserving, flight planning and aircraft rental has endured for decades and currently forms the basis of flight school and flying club operation. In order to maximize fleet utilization, operators make an effort to ensure pilots adhere to strict timing, and apply significant energy to fleet logistics, defect management and to resolving mechanical and procedural anomalies that arise.

### SUMMARY

According to one aspect there is provided a computer implement method of aircraft selection. Parameters and a set of logical rules reflecting laws, regulations and policies relating to safe operation of an aircraft are provided, along with a database of aircraft relating to a fleet of aircraft of the same type. The database of aircraft has static aircraft data for each aircraft that does not change and transient aircraft data that is frequently changing. The static aircraft data includes: basic empty weight and basic empty moment, safe operating weight and balance envelope for aircraft, and any specific aircraft limitations. The transient aircraft data includes: availability, fuel level, and time until maintenance is required. A computer processor is provided which is capable of processing the parameters and set of logic rules along with information from the database of aircraft. There is input into the computer processor a request for an aircraft to a mission at a time a pilot declares readiness for an aircraft. The request consists of data regarding the mission including a minimum of: a proposed air time, a weight and seat position of each occupant of the plane, weight and position of cargo, if any cargo will be carried. The computer processor makes a selection from the database of aircraft a first subset of aircraft that are available and capable of safely performing the mission.

If there is more than one aircraft in the first subset, the final selection of a single aircraft can be made arbitrarily and safely by administrative personnel. However, it is preferable that the computer processor be programmed to make a selection from the first subset of a single aircraft. There are different ways that this can be done. The selection from the first subset may be made on the basis of a single aircraft having the least remaining useful load capacity. The selection of a single aircraft from the first subset may be based upon distributing fleet aircraft maintenance due dates. It is preferred that a combination of these two final selection methods be used. These final selection methods do not directly concern safety, but they can have a tremendous positive economic impact on fly club operations, as aircraft with greater capacity remain available for other missions and maintenance scheduling can be managed so that a minimum number of aircraft are out of service at a time.

The above described aircraft selection method can be employed by having fuel tanks always full for each rental or leaving fuel calculations and the decision on fuel required for the mission up to the pilot. However, it is simplifies operation of the flying club if constant refueling is avoided. Pilot calculation error can be avoided by automating the selection process. In order to do so the static aircraft data includes fuel bum rate and fuel capacity. This enables the computer processor to take into consideration fuel burn rate, fuel capacity, and the transient aircraft data relating to fuel level when determining whether an aircraft is capable of safely performing the mission.

There are various ways in which a human interface with the computer processor may be configured. As will hereinafter be described, beneficial results have been obtained by providing the following interfaces. It is preferred that the input screen be a graphic interface depicting each seat and cargo area in the aircraft. This simplifies input so that input merely involves inserting an occupant weight into each seat and a cargo weight into each cargo area. It is also preferred that an aircraft fleet console is generated indicating which aircraft are unavailable as they are in flight, which aircraft are unavailable due to maintenance, and which aircraft are available subject to fulfilling the mission parameters. It is finally preferred that, concurrently with making the selection of a single aircraft, the computer processor generates a graphical representation of the aircraft's weight and balance data relative to the aircraft's safe operating weight and balance envelope.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a system overview showing the aircraft selection method in the context of the dispatch software, computer system and interne access to it; and

FIG. 2 is an overview of the inputs and outputs of the aircraft selection method; and

FIG. 3 is a more detailed depiction of the inputs and outputs of the aircraft selection method; and

FIG. 4 is a flow chart showing the logic embodied in the aircraft selection method.

FIG. 5 is a screen shot of an input template for inputting mission parameters in accordance with the aircraft selection method.

FIG. 6 is a screen shot of an aircraft assignment console in accordance with the aircraft selection method.

FIG. 7 is a screen shot of an aircraft weight and balance envelope output in accordance with the aircraft selection method.

FIG. 8, is a screen shot of the dispatch system main interface in accordance with the aircraft selection method.

### DETAILED DESCRIPTION

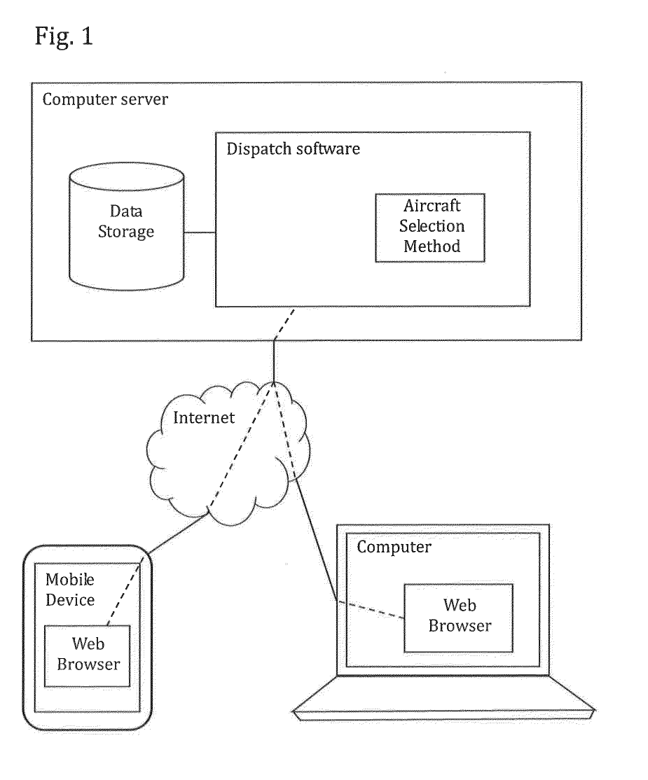

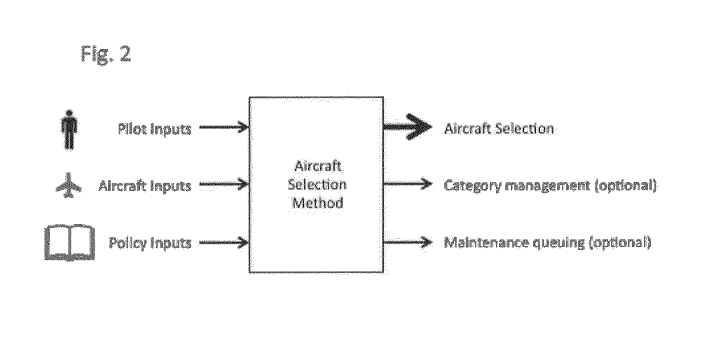

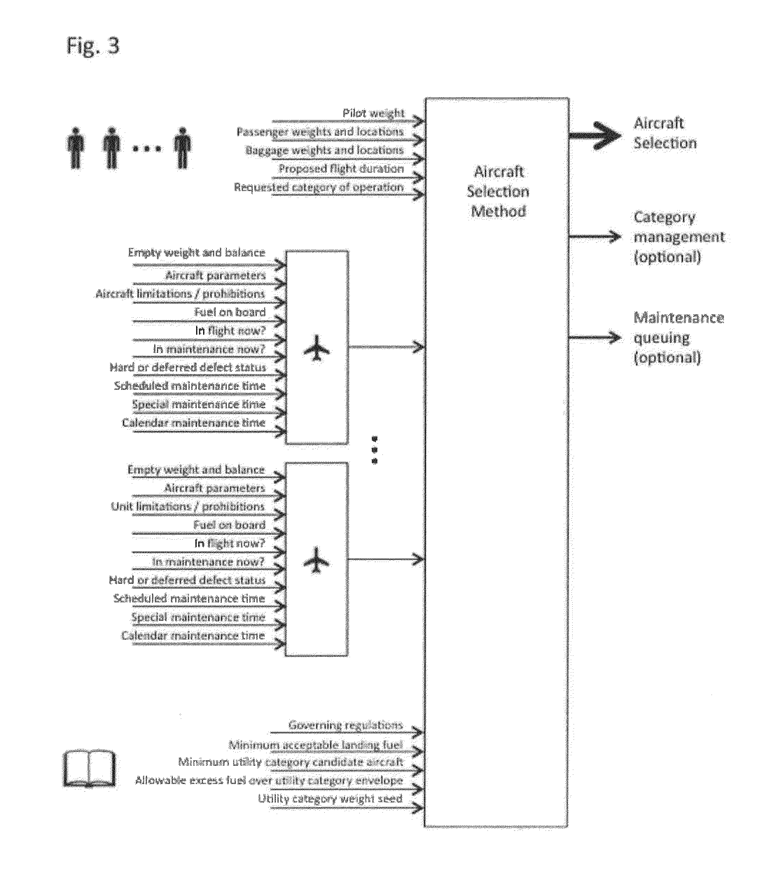

An aircraft selection method will now be described with reference to FIG. 1 through FIG. 8. The aircraft selection method is a computer software based method used to select an aircraft from a fleet of aircraft. It was developed for use with a Flight Training Unit, but may have broader application.

There is provided a computer based method for selecting an aircraft from a fleet of aircraft and assigning that aircraft to a pilot for flight, ensuring that the aircraft satisfies all regulatory requirements and is suitable for the pilot's stated mission. The fleet analysis, aircraft selection and assignment are done immediately prior to the intended flight, rather than at the time of reservation. The selection is based on a pilot's stated mission, of each candidate aircraft's static and current transient data, and considering the operator's policies, governing regulations and laws applicable to the safe operation of the aircraft. The computer based selection method resides within an aircraft dispatch software program Which allows a dispatcher or multiple dispatchers to control the assignment of many aircraft to many pilots, return those aircraft to the fleet after flight, monitor and track critical aircraft data over time, assess constantly changing fleet utilization and capacity, while lending support to re-fuelling decisions, maintenance planning, defect management, record keeping and billing. The aircraft selection method, in addition to fulfilling the pilot's requirements, can optionally embody enhancements that optimize aspects of the operator's business. Where multiple aircraft may equally satisfy a pilot's mission requirements, aircraft selection is made such that aircraft having higher load carrying capacity are retained for subsequent pilots whose currently unknown missions may require the higher capacity. Where multiple equal or nearly equal aircraft remain available to satisfy the pilot's requirements and meet the minimum capacity objective, a selection is made which tends to evenly distribute the expiration of aircraft scheduled maintenance times, thereby reducing the probability that maintenance staff will be overloaded at any given point in the future. The computer based selection method allows pilots to reserve an intended aircraft type (not a specific aircraft) and flight time. This allows the operator to better manage the natural gaps between reservations, essentially overbooking to fill the gaps. The capacity of the fleet is thereby increased, satisfying more pilots both at the time of reservation and at the time of flight. The computer based selection method allows flexibility in operation and timing. If a plane requires unscheduled maintenance, no cancellations need occur—another suitable aircraft is selected and assigned. If the pilot arrives early or late, needs more preparation time or wants to lengthen or shorten the flight, that is accommodated because the aircraft is selected only when needed, and is returned to the fleet ready for the next pilot soon after the aircraft lands. If a pilot has no reservation but makes a spontaneous decision to fly, there is a much higher probability that the flight can be accommodated and that other pilots won't be adversely affected. in summary, a computer based aircraft selection method increases the effective capacity of a fleet of aircraft and increases the flexibility that can be afforded in applying that capacity to a population of pilots.

The selected aircraft satisfies the requirements of a mission defined by the pilot, and satisfies the regulations governing flight operations. The aircraft selection method exists within a software program (“dispatch software”) that is designed to support the dispatch operations of a flying school. The dispatch software enables the human dispatcher to enter details of the pilot's stated mission, effect an aircraft selection, monitor the fleet of aircraft, anticipate aircraft returns and subsequent dispatches, manage maintenance activities and scheduling, manage aircraft defect status and handling, manage fuel levels and oil consumption, and enable various administrative and billing functions. The package of features and capabilities of the dispatch software will be subject to continuous evolution and improvement as interfacing processes, creative new ideas and technical advances stimulate further development. The aircraft selection method exists at the core of the dispatch software and is central to the dispatch system operation. The aircraft selection method accepts three categories of inputs: pilot inputs, aircraft inputs and policy inputs. These inputs are gathered by the selection method, processed and used to supply the dispatch software with up to three results: a selected aircraft (if one is available), optionally fleet category management, and optionally maintenance queue management. The dispatch software processes, packages and presents these results along with other information to the human dispatcher to support the operational dispatch process and allows an aircraft to be assigned to a pilot. The dispatch software resides in a computer. That computer can be any computer accessible to the dispatcher's computer. It can be a computer on the local network, or more generally, any computer connected to the internet accessible using a web browser. The dispatch software communicates with a database. The database is data storage that contains fixed and transient information describing aircraft, dispatches, flights, and maintenance schedules. The data storage can be located in the same computer as the dispatch software, or any computer or computers accessible to the dispatch software, either locally or using the internet. The dispatch software is accessed using a web browser running on the dispatcher's computer. At minimum, one dispatcher interface to the dispatch software is required. That interface is typically used by a dispatcher at a fixed location using a desktop computer. There can be multiple dispatchers using multiple computers to access the dispatch software. There is no requirement for these computers to be closely co-located but typically they would be. The dispatcher software can be accessed by one or more optional interfaces designed to support specific functions. For example, a mobile device with a web browser can access the dispatch system using an interface designed to add or remove fuel from aircraft and to monitor the addition of oil to an aircraft. Typically one or more line persons service the aircraft by adding fuel and record the new fuel level into the dispatch software using a web browser on their mobile devices. This information, which in the context of a fleet of aircraft changes minute by minute, is immediately available to the aircraft selection method and constitutes one input to the aircraft selection process. The dispatcher does not need to be aware of fuelling activities or results, and can focus on meeting the pilot's needs and entering the pilot mission into the dispatch system. The aircraft selection method will use all current information provided by all dispatchers and line persons to select the most suitable aircraft for each mission. A maintenance interface supports maintenance personnel in the performance of fleet management functions, such as adding or deleting aircraft, and provides support for maintenance scheduling and planning activities.

As stated above, the aircraft selection method requires three types of inputs: pilot inputs, aircraft inputs and policy inputs. The pilot input characterizes the mission, specifically the weight and location of each component of the cabin load, the proposed flight duration and, for some common training aircraft, the requested category of operation. An aircraft's suitability for flight depends, amongst other things, on the total weight of the loaded aircraft, the forward and aft balance condition of the loaded aircraft and various loading and operational rules. For example, a particular baggage compartment may have a weight limit. Or a combination of several compartments may have a combined weight limit. These operational restrictions are set out in chapter 6 of the Pilot's Operating Handbook, sometimes referred to as the Aircraft Flight Manual. In addition to loading rules, an aircraft may have operational limits that allow or prohibit various flight manoeuvres depending on the aircraft's load. In one example a training aircraft may have four seats, two at the front and two immediately behind. The pilot typically sits in the front left seat. The passengers can sit in any of the remaining seats. An aircraft's weight is calculated by adding up the passenger and baggage weights. The aircraft's centre of gravity is calculated based, amongst other things, on the position of the passengers and baggage in the aircraft. This requires knowledge of individual passenger weights and knowledge of which seats they will occupy. So the required inputs include each passenger's weight, each passenger's seating position, the weight of baggage and the position of that baggage in the various baggage compartments. The pilot must also declare the intended flight duration. In addition to helping to manage the fleet schedule, the flight duration is required to calculate the fuel that will be burned during the flight. That, along with a defined fuel reserve sets a lower limit on the amount of fuel that must be on board to safely support the intended mission. That amount of fuel is known as the minimum departure fuel. The aircraft selection method will not select an aircraft for a mission if the fuel on board is less than the minimum departure fuel. Some aircraft have more than one category of operation. Training aircraft often define a normal category and a separate utility category of operation. These categories are defined by a two dimensional area on a graph of aircraft loaded weight and moment, if the loaded (take-off) weight and balance is within the normal category, then flight manoeuvres are limited to those set out for normal category operations. If the aircraft's take-off weight and balance is located in the utility category, additional manoeuvres may be allowed, as set out in the Pilot's Operating Handbook. If a pilot intends to conduct flight operations that require the weight and balance to be in the utility category, he declares that intention. That information is one input to the aircraft selection method that determines an aircraft's suitability for the mission. If a pilot were considering only one previously selected aircraft he could use the aircraft's empty weight and balance and the assumed fuel quantity to complete the weight and balance calculations and verify the intended operation is permitted. But given that the dispatch system considers a fleet of aircraft and allocates a plane to a pilot immediately prior to flight, the aircraft selection method assesses every aircraft in the fleet, given the pilot's mission, the last known or estimated fuel in each plane and various other criteria to select a plane that matches the requirements of the mission.

The second type of input to the aircraft selection method is aircraft data. This data includes the empty weight and balance of the aircraft. Each aircraft has a unique empty weight (defined as its basic empty weight), and empty moment. These are carefully measured and calculated by maintenance personnel in accordance with aviation regulations. They are fixed parameters for an aircraft—meaning that they can change from time to time as an aircraft's configuration or equipment is changed, but don't change day-by-day or hour-by-hour. Each aircraft has a set of parameters that define its allowed flight envelope. These include, but are not limited to the maximum gross (loaded) weight, the fuel capacity, average fuel burn rate, and for some aircraft types may include additional parameters such as maximum utility category weight, maximum zero fuel weight, maximum landing weight amongst others. Applicable parameters are stored in the database and can be changed from time to time by the dispatcher or by maintenance personnel. Some aircraft have technical limitations or are subject to operating rules that set restrictions on flight operations. These are stored in the database and made available to the aircraft selection method as part of the selection process. Each aircraft has a fuel capacity, and at any given time has an amount of fuel on board. This fuel amount changes during the day as the aircraft are operated and re-fuelled. Sometimes an aircraft may be too heavy for its intended operation. In that case fuel can be removed or another aircraft selected. Often there is insufficient fuel to support the intended flight duration and fuel may be added, or another aircraft selected. In any case the current fuel on board is known to (or in some cases estimated by) the dispatch software and is used by the aircraft selection method to ensure that minimum departure fuel and maximum allowable fuel limitations are respected. An aircraft may unavailable for selection and assignment at any given time due to a number of transient conditions including: The aircraft is already in flight, the aircraft is in maintenance, the aircraft has a defect which requires maintenance, a maintenance item will become due during the intended flight or during the calendar time of the intended aircraft rental. In addition, a deferred defect condition may make the aircraft suitable for some missions and unsuitable for others depending on the nature of the defect. The dispatch software brings a defect condition to the attention of the dispatcher for discussion with the pilot to determine the suitability of an aircraft for the intended mission. There are three forecast maintenance conditions that have a bearing on whether an aircraft is suitable for selection: Regular scheduled maintenance, special scheduled maintenance items and calendar based maintenance items. Regular scheduled maintenance occurs at predetermined intervals measured by hours of aircraft operation. Special maintenance items define a number of operating hours at which some particular aircraft component needs service, and calendar based items define particular days by which a service item is due. When a maintenance item is due the aircraft must be taken out of service. So the aircraft selection method analyses each aircraft to ensure that present and upcoming maintenance items permit the intended flight.

The third type of input to the aircraft selection method is policy input. In some cases the inputs of this type comprise binding limits on aircraft operations and in other cases comprise non-binding operator practice or preference in the operation of the fleet. Data relating to governing regulation directs the behaviour of the aircraft selection method dealing with weight and balance limits, maintenance limits and defects. In the case of weight and balance, the aircraft's flight envelope is defined in the Pilot's Operating Handbook (“POH”) and determines if a particular aircraft loading is acceptable or not. During aircraft assessment the passenger, baggage and fuel loads are added to the basic empty weight then a small increment is subtracted to account for fuel burned on the ground prior to take-off. The resulting take-off weight and balance is compared to specific weight and balance envelopes contained in each aircraft's POH to determine if the aircraft can be dispatched. If the aircraft can be dispatched, and the aircraft is capable of supporting both normal and utility category operations, a determination is made of whether the take-off weight is in the normal category of the flight envelope or the utility category of the flight envelope. Utility category loadings can satisfy missions requiring utility or normal category operations, but normal category loadings are not suitable for missions requiring utility category manoeuvres. If the take-off weight and balance falls outside both the normal and utility category envelopes, the aircraft is not fit for flight and must not be dispatched. In some cases, the take-off weight and balance falls outside the utility category envelope, but within the normal category envelope, and calculations show that the aircraft will enter the utility category envelope when a small amount of fuel is burned. In that case, the operator may dispatch an aircraft loaded in the normal category for utility category operations under the condition that the pilot will not perform any utility category manoeuvres until the fuel falls to, or below a calculated level which causes the aircraft's loading to enter the utility category. Where applicable the aircraft selection method calculates the fuel level below which each aircraft can be operated in the utility category. The amount of fuel that an aircraft can carry above the utility category threshold is subject to operator policy and can be set to a level that achieves the required balance between aircraft availability and aircraft utility. Aviation regulations set out rules regarding the performance of scheduled and special maintenance. If any maintenance item falls due and is not done, the aircraft cannot be dispatched. Regulations require defects to be handled in accordance with a defined process. If a defect has not been deferred, the aircraft cannot be dispatched for flight. if an aircraft has a defect that has not been repaired, but has been deferred by a qualified person, that aircraft can be conditionally dispatched, subject to the operator and the pilot agreeing that the defect will not materially affect flight operations. The operator establishes some policies to simplify and clearly control the dispatch of aircraft. For example, the operator may have a policy that determines a fuel amount which is the minimum fuel amount that an aircraft is expected to have on board after landing. The aircraft selection method calculates the expected fuel burn during flight using the proposed flight duration and adds this amount to the minimum landing fuel to establish a minimum departure fuel. Each aircraft will then be assessed as meeting or not meeting the minimum departure fuel requirement and is made available or unavailable for dispatch accordingly. There are a number of optional calculations that can be performed by the aircraft selection method. For example, as stated above, a mission that requires normal category operation can be satisfied by an aircraft loaded either in normal or in utility categories. While it would be possible to seek only normal category aircraft to satisfy normal category missions, such a selection might cause normal aircraft to be selected more frequently than utility category capable aircraft. In the event that there is an abundance of utility category aircraft, then all aircraft, normal and utility can be equally considered for normal category missions. If there is not an abundance of utility category aircraft, then it is prudent to consider all normal category aircraft before considering a utility category aircraft to satisfy a normal category mission. This will ensure that utility category aircraft will be available for the next pilot who may need it. The determination of what constitutes “abundance” is set by the operator, to spread the load over the fleet as evenly as possible, while ensuring that utility aircraft are available for pilots when they are needed. The aircraft selection method uses this operator input to make optimum selections where multiple aircraft can satisfy the requirements of the mission. Another example of an optional calculation made by the aircraft selection method is determining a recommended re-fuelling level for utility category aircraft. If an aircraft capable of utility category operation is given a full load of fuel, it may not be able to satisfy utility category operations until the fuel load is lighter. So the operator may want to fill these aircraft to a fuel level less than full, striking a balance between the number of re-fuelling operations required and the availability of the aircraft as a utility category aircraft. The aircraft selection method can determine, using the aircraft's basic empty weight and balance, and the aircraft's flight envelope whether it is a candidate for utility category operations or not. If it is, the aircraft selection method can take an operator input representing a prescribed cabin weight (typically a student pilot and an instructor) and determine how much fuel will provide the best balance between permitting utility category operations and minimizing the need to frequently re-fuel the aircraft.

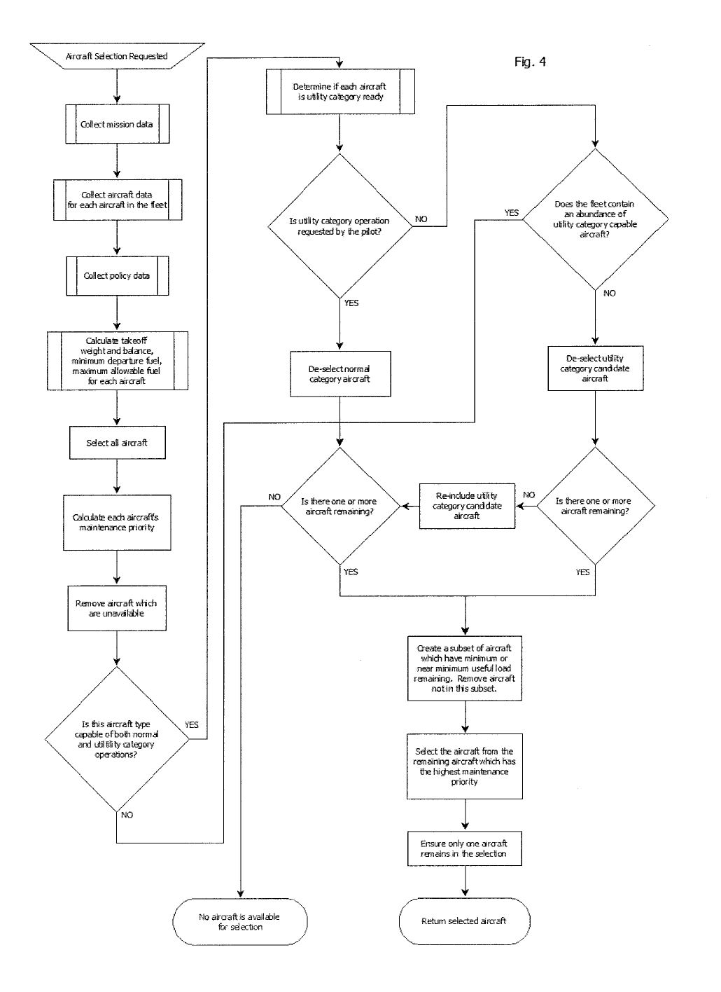

The logic used within the aircraft selection method is described with reference to FIG. 4, An aircraft selection is initiated by the dispatch software due to an action made by the human dispatcher. When the aircraft selection method is triggered a process of information gathering, processing and analysis begins. The order of some operations may vary depending on the implementation details and the dependencies therein. The aircraft selection method refers to data input by the dispatcher, and to data resident in the database, First the aircraft selection method gathers the mission data comprised of: the weight and location of each person on board, the weight and position of all baggage on board, the proposed flight time and the presence or absence of a request to conduct special operations, if applicable, which require a plane loaded in the utility category. Next the aircraft selection method collects aircraft data for each aircraft in the fleet, and the policy data, both of which are described above. Each aircraft is subject to a number of calculations: zero-fuel weight, various pre-flight and post-flight estimated and actual fuel levels, take-off weight, maximum allowable fuel, minimum departure fuel, envelope categories for zero fuel weight and take-off weight, baggage rule compliance, fuel at utility category transition, utility category candidacy and utility category readiness. The basic data for the mission, the aircraft and policies collected, the aircraft selection method first selects all aircraft, then removes aircraft that don't qualify for the mission, eventually leaving one aircraft, if at least one is available for selection, or no aircraft if none remain available to satisfy all the criteria. Optionally, the aircraft selection method assigns each aircraft a maintenance priority. An aircraft's maintenance priority is higher if selecting that aircraft would more effectively distribute the workload on maintenance staff, and is lower if the aircraft's selection would less effectively distribute the maintenance load. The next step in the aircraft selection method is removing aircraft that are unavailable. An aircraft is unavailable if any of the following conditions are true: a maintenance item is due or past due, the aircraft is in maintenance, the aircraft has a defect that has not been corrected or deferred, the aircraft is currently dispatched, the aircraft contains less than the minimum departure fuel, the aircraft contains more than the maximum allowable fuel, the baggage rules are broken, the take-off category is outside of the normal category envelope (and the take-off category is outside of the utility category envelope, if applicable) and another dispatcher is currently dispatching the aircraft. After removing unavailable aircraft the aircraft selection method takes one of two actions depending on whether or not this model of aircraft is capable of both normal and utility category operations. If both categories are possible, then the aircraft selection method determines each aircraft's readiness for utility category operation. An aircraft is ready for utility category operation if its take-off weight and balance is in the utility category, or if its weight and balance will be in the utility category after an allowable small amount of fuel is consumed. If utility category operation is requested as part of the mission, the aircraft selection method removes aircraft that are loaded in the normal category. if after this removal, there are no aircraft remaining in the selection, the selection process is complete. There are no suitable aircraft to assign to the pilot for this mission. If one or more aircraft remain, any of them could be selected resulting in an aircraft that would equally satisfy the pilot's mission. However the aircraft selection method can optionally add value for the operator by making a selection that makes better use of the fleet. For example, when multiple aircraft can satisfy a pilot's mission, it is prudent to select an aircraft from the candidate aircraft that has the least remaining load-carrying capacity. In so doing, aircraft having a greater load carrying capacity are retained for the next pilot's currently unknown and possibly more demanding requirements. The aircraft selection method creates a subset of the remaining aircraft that have the least remaining capacity. There may be several aircraft remaining in this subset each of which has the least or close to the least remaining capacity. Aircraft having a higher capacity are removed from the selection. Optionally, a single aircraft is chosen from the remaining aircraft having the highest maintenance priority. At this stage, there is one aircraft remaining and it is returned to the dispatch system as the selected aircraft. if any of the two preceding optional steps are not employed, there is one or more aircraft left in the selection. If there is more than one aircraft remaining, one aircraft is selected using any method desired. Earlier in the selection method, if we had determined that the aircraft is not capable of both normal and utility category operation, aircraft selection would proceed to the latter stages of selection and follow the remainder of the selection process as described above. If utility category operation was not selected by the pilot the aircraft selection method determines whether there are an abundance of utility category aircraft remaining. If there are an abundance, it would be undesirable to de-select these aircraft, because such a de-selection would tend to unnecessarily bias the use of the normal category aircraft. If selecting a utility category aircraft for a normal utility mission does not materially reduce the probability that a subsequent pilot's mission has a utility category aircraft if required, then the aircraft selection method retains all normal and utility aircraft in the selection subset and proceeds with the remainder of the selection process. If there is not an abundance of utility aircraft remaining, the aircraft selection method will initially exclude the utility category aircraft from to avoid unnecessarily selecting a utility category aircraft when a normal category aircraft could fulfil the mission. This ensures that a subsequent pilot who may require a utility category aircraft has a high probability of finding one available. If after the utility category aircraft are de-selected there is one or more aircraft available, a selection is made from that subset following the steps described above. If there are no normal category aircraft remaining that satisfy the pilot's mission, then in a last effort to make a selection, the utility category aircraft are re-selected and the remainder of the selection process proceeds as described above. In summary, when the dispatch system triggers a request for aircraft selection the aircraft selection method returns one aircraft in accordance with the method, if a qualifying aircraft is available for selection, otherwise no selection is returned if there are no aircraft that can satisfy the pilot's mission.

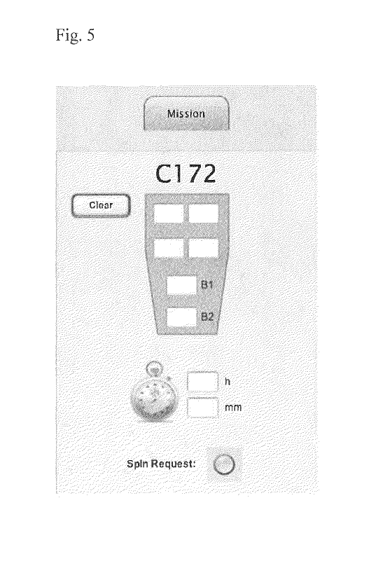

Referring to FIG. 5, there is illustrated a screen shot of an input template for inputting mission parameters. The input template is the means by which a dispatcher enters the pilot's mission data. At the top of the form the aircraft type is displayed. In the example of FIG. 5, the type identifier “C172” is shown. C172 is the globally standard identifier of the Cessna 172 aircraft type. Below the type identifier is a graphic enclosing six input fields. The graphic represents a top view of the cabin of an aircraft, illustrated in a manner similar to that used by aircraft manufactures in the Pilot's Operating Handbook. The six input fields represent aircraft positions which can each be loaded with weight. In FIG. 5, the front left seat has been loaded with 200 pounds, and the front right seat has been loaded with 200 pounds. Each of the two rear seats, and each of the two baggage compartments are empty in this example. The next section, to the right of the stopwatch graphic is comprised of two input fields collectively used for inputting the pilot's proposed flight time. In the example of FIG. 5, the dispatcher has entered the pilot's intention to conduct a flight having duration of one hour fifteen minutes. The next section is used to input any special flight conditions or manoeuvres that may be requested by a pilot. In this example, there is only one such request possible; a request to conduct spins. If the dispatcher clicks on the Spin Request button, it will toggle from an off condition, to a coloured condition. The coloured condition indicates whether the aircraft selection method has been successful in selecting an aircraft that can satisfy the request. In this example, the light graphic has become green indicating the aircraft selection method has found an aircraft that can satisfy the spin request given the cabin weights and proposed airtime required by the pilot. The clear button clears all inputs and removes the spin request making the form ready for alternate input by the dispatcher.

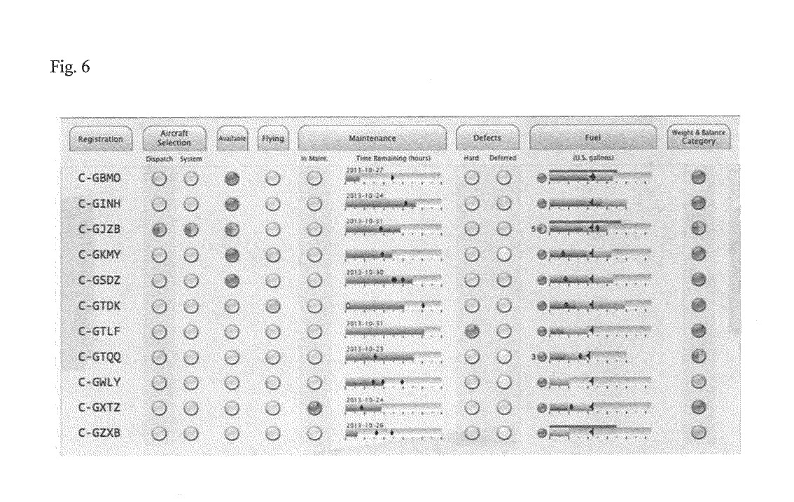

Referring to FIG. 6, there is illustrated a screen shot of an aircraft assignment console. The console provides a summary of the fleet including an indication of the important transient characteristics of each aircraft. Transient characteristics can change from moment to moment, and include items such as whether the aircraft is flying or not, whether it is in maintenance, its maintenance times remaining, whether it has a defect, and current fuel level. Each row in the console represents one aircraft in the fleet. At the far left column, the aircraft's registration is displayed. An aircraft's registration is a unique identifier that is similar to a licence plate number for an automobile. For example, C-GBMO is the registration of the first aircraft in the eleven aircraft list in FIG. 6. Each of the small round coloured graphics (“lights”) provides information about the aircraft. Lights that are located within a tan coloured area can be pressed, or clicked in order to change their condition. For example, if C-GBMO's “In Maint.” light under the Maintenance tab is pressed, the colour will change from neutral, indicating off, to red, indicating that C-GBMO is in maintenance. In that event, C-GBMO's blue light under the Available tab will toggle from blue to off, indicating that C-GBMO is unavailable for dispatch. The aircraft selection method uses all such information, automatically as it is entered to make or revise the most appropriate aircraft selection as described above. A brief description of each column in the console follows: Under the Aircraft Selection tab are two lights. The System light indicates the result of the aircraft selection method. Given all the inputs required by the aircraft selection method, including the mission inputs described in FIG. 5, the aircraft selection method will make its selection and indicate the result by lighting the appropriate System light. In the example of FIG. 6, the System light has been lit for C-GJZB. That indicates that C-GJZB has been selected by the aircraft selection method. The colour, or split colour in this example, is a code illustrating the weight and balance category of the selected aircraft. A blue light indicates that the selected aircraft is loaded in the normal category, a green light indicates that the aircraft is loaded in the utility category. A split light, as in the example, indicates that the aircraft is initially loaded in the normal category, but will transition to the utility category when a small amount of fuel is consumed. In this example, the small light under the Fuel tab has the number “5” immediately to its left. That informs the dispatcher that C-GJZB will enter the utility category after 5 gallons of fuel is consumed. Returning to the Aircraft Selection lights; the Dispatch light is lit in this example, and indicates C-GJZB has been confirmed by the dispatcher. Should the dispatcher have some reason to manually select a different aircraft, that selection can be made by clicking on the Dispatch light of any other aircraft. The Dispatch light for C-GJZB will then extinguish, and the selected light will illuminate. The selected Dispatch light's colour will depend on the aircraft's loading and other conditions. If the dispatcher were to select an aircraft that is unavailable the light would become red. The Available light identifies aircraft that are available for dispatch. Availability depends on a variety of conditions being satisfied, including the aircraft must not already be flying, it must not be in maintenance, it must not have a hard defect, etc. The Flying light indicates that the aircraft of interest has already been dispatched. The Maintenance tab contains two items; an In Maint. light and a Time Remaining (hours) graphic. The In Maint. light illuminates red when the aircraft is having maintenance performed on it. The Time Remaining graphic shows the status of three maintenance timers; the amount of time remaining before scheduled maintenance is due (depicted by the grey bar), the amount of time remaining until each special maintenance item is due (depicted by the black diamonds) and the date at which the next calendar-based maintenance item is due, if any, depicted by the date located immediately above each respective maintenance graphic. There are two lights located under the Defects tab. The Hard light indicates that a defect has been identified for an aircraft and has not been corrected or deferred. This condition, if it exists, will prevent the aircraft selection method from selecting this aircraft for assignment. The Deferred light is illuminated yellow When selected. This condition indicates that a defect has been identified, but that defect has been evaluated by a qualified person, and that person has determined that the aircraft is suitable for flight. In fact the resolution of the defect has been deferred until a future time. When a deferred defect exists, the particulars of the defect are noted in the dispatch system and are shared with the pilot prior to flight. It is then the pilot's responsibility to determine whether or not the defect is material to the safety of the proposed mission. Information about each aircraft's fuel is contained under the Fuel tab. The small light indicates the weight and balance of the aircraft with the proposed mission, if applicable. But if the fuel on board is either insufficient for the proposed flight duration, or is too much such that the weight and balance is out of the normal or utility category, the light will be red. Otherwise the light will be illuminated with a colour depicting each aircraft's category of operation. The fuel gauge graphic depicts a number of fuel-related parameters, if applicable, to provide the dispatcher with a one-glance indication of the fuel situation for each aircraft. The main fuel bar extends to the point of the last known fuel quantity for each aircraft. A blue segment indicates the fuel that is expected to be burned during the current flight and is applicable only for aircraft that are in the air. By evaluating the left edge of the blue segment the dispatcher can estimate how much fuel is likely to be on board when an aircraft returns from a flight. A light green segment indicates fuel that would be burned if the currently proposed flight were to be conducted using each plane. A dark green segment indicates the amount of fuel on board net of any fuel burned by a flight currently in progress, if applicable, in addition to the proposed flight being considered. The fuel gauge background extends to the fuel capacity of the aircraft. In FIG. 6, the fuel gauge of C-GINH extends to 40 gallons, while the gauge for G-GJZB extends to 53 gallons depicting graphically the different fuel tank capacities of each respective aircraft. Superimposed over the fuel gauge are several indicators, not all of which are present at all times. When a proposed air time has been entered, a small red flag with a left pointing arrow appears which depicts the minimum departure fuel. Flight is not allowed if the fuel on board an aircraft has less than the minimum departure fuel quantity. If the aircraft is quite heavily loaded with weight, a maximum allowable fuel flag will appear. The maximum allowable fuel flag is a similar red flag with the arrow pointing to the right, if the fuel on board exceeds the maximum allowable fuel, the aircraft will be loaded outside the acceptable weight and balance envelope and may not be flown. If the maximum allowable fuel exceeds the aircraft's fuel capacity, no flag is shown. Finally, a magenta coloured diamond sometimes appears. If applicable, this diamond depicts the fuel level at which the aircraft would transition from the normal category to the utility category. In FIG. 6, C-GJZB would transition from the normal category to the utility category when the fuel remaining is equals 25 gallons. The final light on the console is under the tab Weight & Balance Category. This light can be clicked to display a weight and balance graphic for any aircraft in the fleet. This would be useful if the dispatcher were curious about various aircraft's capacity to safely perform a proposed mission. The light, whether clicked or not, always provides minimum data (blue, green or split) indicating the weight and balance condition of each aircraft given the mission being considered.

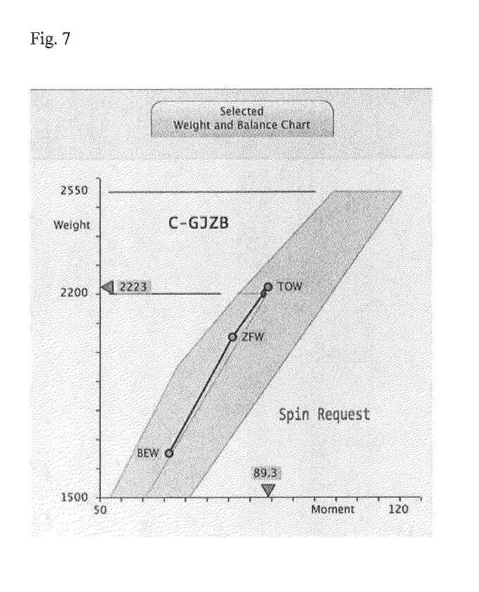

Referring to FIG. 7, there is illustrated a screen shot of an aircraft weight and balance envelope graphic. A weight and balance graph is a tool used by pilots to determine that the aircraft will be operated within acceptable loading limits. The graphic in FIG. 7, generated by the dispatch system provides information for the pilot and the dispatcher. The x-axis of the graph depicts the balance condition of the aircraft in the forward and aft direction. This balance condition, or moment, has units of thousand pound inches in this example, and is illustrated by a triangle near the x-axis. The colour of the triangle corresponds to the take-off category of the aircraft; green meaning utility category, blue meaning normal category and red meaning outside both the normal and utility categories. The y-axis depicts weight, in this example, in pounds. The triangle adjacent to the y-axis is coloured to correspond with the category of aircraft operation. The selected aircraft's registration is shown and the specific envelope for that aircraft depicted. There are aircraft to aircraft differences in envelopes which are stored in the database and used by the aircraft selection method as inputs to the selection process. The loading line drawn on the chart begins at the bottom left at the basic empty weigh (BEW) point. This point depicts the basic empty weight and balance of the aircraft and won't typically change from flight to flight. It will change if the aircraft's configuration has changed, perhaps by adding some new navigation equipment to the aircraft, for example. The loading line extends from the BEW point to the zero fuel weight and balance (ZFW) point. The ZFW point depicts the weight and balance of the aircraft including its load of people and baggage, but excluding fuel. The loading line extends upward from the ZFW point to the take-off weight and balance point (TOW). The position of the TOW point relative to the safe operating weight and balance envelope indicates whether the aircraft is suitably loaded to conduct the intended mission. A pilot can verify this, and verify that the aircraft will remain suitably loaded as fuel is consumed. For some flights, such as for the flight depicted in FIG. 7, the pilot can verify that the aircraft will soon enter the utility category of operation (depicted as the green area on the graph. The fact that the pilot in this example has requested spin manoeuvres is noted in text on the chart. Using this chart, the pilot and dispatcher can each verify at a glance that the proposed load together with the selected aircraft will result in a safely loaded aircraft.

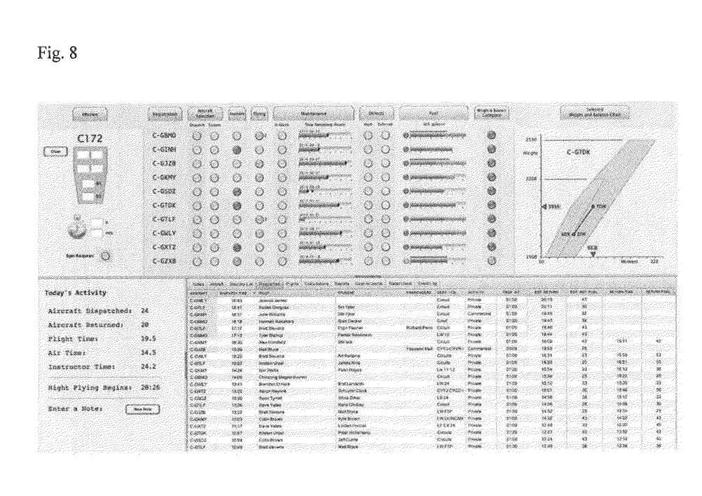

Referring to FIG. 8, there is illustrated a screen shot of the dispatch system main interface. As an overview, FIG. 8 shows the relative position of the input form, the console and the weight and balance graphic. Below these three areas are two additional panes in this example will be discussed in overview. The pane at the lower left contains a context dependent form. The form that occupies this space depends on the function the dispatcher is performing. In FIG. 8 the Dispatching form is shown, which allows the dispatcher to enter information about the pilot and the intended mission. Other forms include the return form, and a variety of forms related to aircraft maintenance and parameter management, billing and system parameters. The pane to the lower right contains a variety of tables, selectable by clicking on the tabs located immediately below the pane boundary. These tables contain records of activity and aircraft data for easy review, sorting and reporting. The dispatch system allows the dispatcher to perform a number of functions, including initiating the aircraft selection method, which is critical to safe and effective selection of an aircraft and assignment to a pilot. The aircraft selection method is initiated automatically and repeatedly, whenever any dependent data is changed. For example, when the dispatcher changes the weight or position of any occupant, a new selection is evaluated. If a spin request is made or cancelled, the aircraft selection method re-evaluates all selection options. If any aircraft's maintenance, defect or fuel situation changes, the aircraft selection method re-evaluates the selection. The aircraft selection method takes all its inputs and makes an aircraft selection in a fraction of a second so the dispatcher can fill in the forms and observe the result without delay.

There will now be described an example of a typical flight input with reference to FIG. 5, FIG. 6, FIG. 7 and FIG. 8. The process of aircraft assignment begins when a pilot declares his readiness to accept an aircraft. The pilot provides the information about each occupant's weight and position in the aircraft, the intended air time of the flight, and whether spins are requested or not. This information is keyed by the dispatcher into the input form as shown in the example of FIG. 5. As soon as the aircraft selection method has enough data (while the dispatcher is still typing) an aircraft will be selected. This selection will be updated as further inputs are received. When all the input has been entered, the aircraft selection method will select the most suitable aircraft then display the selected aircraft by illuminating Aircraft Selection lights as shown in FIG. 6. If the aircraft selection is acceptable to both the dispatcher and the pilot (which is the usual case), the dispatcher can continue to fill in the information in the dispatching form as shown in the lower left corner of FIG. 7. When this is complete, the dispatcher presses the blue Flight Authority button which. evokes a printed summary of all dispatch related data (weight and balance, maintenance, defects, fuel etc.) for pilot review. When satisfied, the pilot and dispatcher sign the flight authority form. The dispatcher presses the Assign Flight button and the dispatch system marks the selected aircraft as flying by illuminating the appropriate light under the Flying tab. A record is then generated and inserted in to the Dispatches table in the lower right panel, establishing a permanent record of the dispatch operation. The pilot is released to the aircraft to conduct the flight. A dispatch operation can typically be done in about one minute.

### Advantages:

Employing a dispatch system that embodies an aircraft selection method provides the pilot and the operator benefits over the long-standing practice used by Flight Training Units and flying clubs. Various advantages are listed here in no particular order.

Because aircraft are selected from a fleet immediately prior to flight, and returned to that fleet immediately after flight, the aircraft utilization rate is higher, hence the effective capacity of a fleet of any given size is increased, resulting in more aircraft availability for pilots and higher revenue for operators.

Because aircraft are dispatched when needed, more flexibility exists to cater to various pilot needs. If a pilot arrives late for a reservation, the operation can generally accommodate the change without difficulty. No aircraft need sit idle, aircraft can be deployed to other pilots who are ready to fly. When the first pilot becomes ready, he can be assigned the next available and suitable aircraft. So the aircraft selection system working within a dispatch system enables an operation where the pilot's changing needs are better accommodated. The pilot can arrive early, or late, or fly for a longer or shorter period than originally hooked and in most cases continue with plans, without risking cancellation or upsetting the logistics of the operator. Flexibility leads to higher pilot (customer) satisfaction. Flexibility exists not only in the timing of a flight, but also in the mission. If passengers are to be added or deleted, or if a utility category request is changed, another aircraft selection is immediately made and the aircraft can be assigned to the pilot without delay. This level of flexibility is impossible without a software based dispatch system employing an aircraft selection method because the number of quickly changing aircraft and mission parameters cannot be managed manually.

The operator's costs are significantly reduced. There are several mechanisms of cost reduction including: The number of re-fuelling operations are reduced—typically to half the previous level. In the present system when a specific plane is reserved, to allow the pilot to do a weight and balance calculation and provide a good possibility of a successful result, each aircraft has to have a known amount of fuel prior to flight, within a fairly narrow range. Alternatively, when using a dispatch system embodying the aircraft selection method, an aircraft with a suitable amount of fuel is selected from a fleet. So typically aircraft can be fully fuelled, and not need fuel for the next few flights. Because a suitable aircraft is selected rather than specifically made ready, more fuel can be added at fuelling time, utility category aircraft can be fuelled with specific intermediate quantities identified by the system both resulting in a much lower re-fuelling cost without sacrificing any utility from the pilot's perspective. Dispatch staff workload is substantially reduced with dispatch system support normally leading to a reduction of dispatch staff and a re-deployment of part of remaining dispatcher's time. The maintenance staffs effectiveness is increased because the workload is more evenly spread by the aircraft selection system, and the maintenance interface of enables more effective planning and scheduling of maintenance activities. Human generated errors in administering the daily flight record and aircraft journey logbooks (both regulatory requirements) are reduced, allowing time to be deployed on customers and other more important tasks.

Higher operator revenue and lower cost results in higher profit which can be used by the operator in any way its owners sees fit, typically including refreshing the fleet and improving the infrastructure to some degree, and/or containing aircraft rental prices to low levels. This leads to higher owner and customer satisfaction which tends to positively contribute to business success.

All flights are safe and legal with the fuel level, weight and balance, operating limitations, maintenance and defect considerations managed by the computer software, with parameters verifiable by both the pilot and the operator. The weight and balance is calculated from the inputs, without error resulting in a printable verifiable record of the flight envelope, the take-off weight and balance and the point at which the weight and balance enters the utility category, if applicable. In all cases, the pilot is responsible that the aircraft is operated in accordance with weight and balance limits. Using existing methods, the pilot's calculations (if any) are typically not shared with the operator. When requested by the operator, the weight and balance may or not be verified by calculation by the operator. When the aircraft selection method is used, the resulting aircraft is known to comply with weight and balance regulations and that information is shared by the operator and the pilot prior to flight, and is verifiable after the flight should any incidents or questions arise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context dearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A computer implement method of aircraft selection, comprising:
providing parameters and a set of logic rules reflecting laws, regulations and policies relating to safe operation of an aircraft;
providing a database of aircraft relating to a fleet of aircraft of the same type, the database of aircraft having data for each aircraft indicating:
static aircraft data, including: basic empty weight and basic empty moment, safe operating weight and balance envelope for aircraft, and any specific aircraft limitations;
transient aircraft data, including: availability, fuel level, and time until maintenance required;
providing a computer processor capable of processing information using the parameters and the set of logic rules together with information from the database of aircraft;
inputting into the computer processor a request for an aircraft to fulfil a mission at a time a pilot declares readiness for an aircraft, the request including data regarding the mission including a minimum of a proposed air time, a weight and seat position of each occupant of the plane, weight and position of cargo if any cargo will be carried;
the computer processor making a selection from the database of aircraft a first subset of aircraft that are available and capable of safely performing the mission.

2. The computer implemented aircraft selection method of claim 1, wherein if there is more than one aircraft in the first subset, the computer processor makes a selection from the first subset of a single aircraft.

3. The computer implemented aircraft selection method of claim 2, wherein the selection the first subset is made on the basis of a single aircraft that has the least remaining useful load capacity.

4. The computer implemented aircraft selection method of claim 2, wherein the selection of a single aircraft from the first subset is based upon distributing fleet aircraft maintenance due dates.

5. The computer implemented aircraft selection method of claim 1, wherein the static aircraft data includes fuel burn rate and fuel capacity, and the computer processor takes fuel burn rate, fuel capacity, and the transient aircraft data relating to fuel level into consideration when determining whether an aircraft is capable of safely performing the mission.

6. The computer implemented aircraft selection method of claim 1, wherein the input screen is a graphic interface depicting each seat and cargo area in the aircraft, and the input involves inserting an occupant weight into each seat and a cargo weight into each cargo area.

7. The computer implemented aircraft selection method of claim 1, wherein an aircraft fleet console is generated indicating which aircraft are unavailable as they are in flight, which aircraft are unavailable due to maintenance, and which aircraft are available subject to fulfilling the mission parameters.

8. The computer implemented aircraft selection method of claim 1, wherein, concurrently with making the selection of a single aircraft, the computer processor generates a graphical representation of the aircraft's weight and balance data relative to the aircraft's safe operating weight and balance envelope.
